(19) United States
(12) Patent Application Publication
(10) Pub. No.: US 2007/0162160 A1
(43) Pub. Date: Jul. 12, 2007

(54) Fan speed control methods

(75) Inventors: An-Sheng Chang, Taipei Hsien (TW); Lien-Chang Tsai, Taipei Hsien (TW); Shun-Chih Huang, Taipei Hsien (TW)

Correspondence Address: BIRCH STEWART KOLASCH & BIRCH, PO BOX 747, FALLS CHURCH, VA, 22040-0747, US

(73) Assignee: GIGA-BYTE TECHNOLOGY CO., LTD.

(21) Appl. No.: 11/527,388

(22) Filed: Sep. 27, 2006

(30) Foreign Application Priority Data
Jan. 10, 2006 (TW) 95100888

(51) Int. Cl. G05B 11/01

(52) U.S. Cl. 700/25

(57) ABSTRACT

Fan speed control methods are provided to dissipate heat from an electric device in a computer system. A load-temperature curve of the electronic device is determined by detecting load and temperature thereof within a working interval. Subsequently, a fan speed-temperature curve is determined according to the load-temperature curve, and the fan speed is controlled according to the fan speed-temperature curve.

### BACKGROUND OF THE INVENTION

1. Field of the Invention

The invention relates in general to fan speed control, and in particular to fan speed control methods for computers.

2. Description of the Related Art

Conventional computers comprise many electronic devices generating heat, such as power supplies, motherboards, and CPUs, having individual load-temperature curves. As shown in FIG. 1, three load-temperature curves C1, C2 and C3 of three CPUs CPU1, CPU2 and CPU3 are distinct from each other due to individual function and electrical properties.

Since high temperatures can reduce efficiency, cooling fans are conventionally provided to dissipate heat from responsible devices. Conventional cooling fans are controlled according to predetermined fan speed-temperature curves, as shown in FIGS. 2, 3, and 4, wherein the fan speed-temperature curves are fixed. In FIG. 2, the fan speed is constant regardless of temperature variation. The fan speed-temperature curve may also comprise multiple segments of different slopes, as shown in FIGS. 3, and 4.

### BRIEF SUMMARY OF THE INVENTION

Fan speed control methods are provided to dissipate heat from an electric device in a computer system. A load-temperature curve of the electronic device is determined by detecting load and temperature thereof within a working interval. Subsequently, a fan speed-temperature curve is determined according to the load-temperature curve, and the fan speed is controlled according to the fan speed-temperature curve.

### BRIEF DESCRIPTION OF THE DRAWINGS

The invention can be more fully understood by reading the subsequent detailed description and examples with references made to the accompanying drawings, wherein:

FIG. 1 is a load-temperature diagram of three different CPUs;

FIGS. 2, 3, and 4 are schematic diagrams of three conventional fan speed-temperature curves;

FIG. 5 is a flowchart of an embodiment of the method for controlling fan speed;

FIG. 6 is a load-temperature diagram in accordance with FIG. 5;

FIG. 7 is a fan speed-temperature diagram corresponding to the load-temperature diagram of FIG. 6;

FIG. 8 is a load-temperature diagram of an electronic device with temperature control circuit (TCC);

FIG. 9 is a fan speed-temperature diagram corresponding to the load-temperature diagram of FIG. 8; and

FIG. 10 is a flowchart of another embodiment of a method for controlling fan speed.

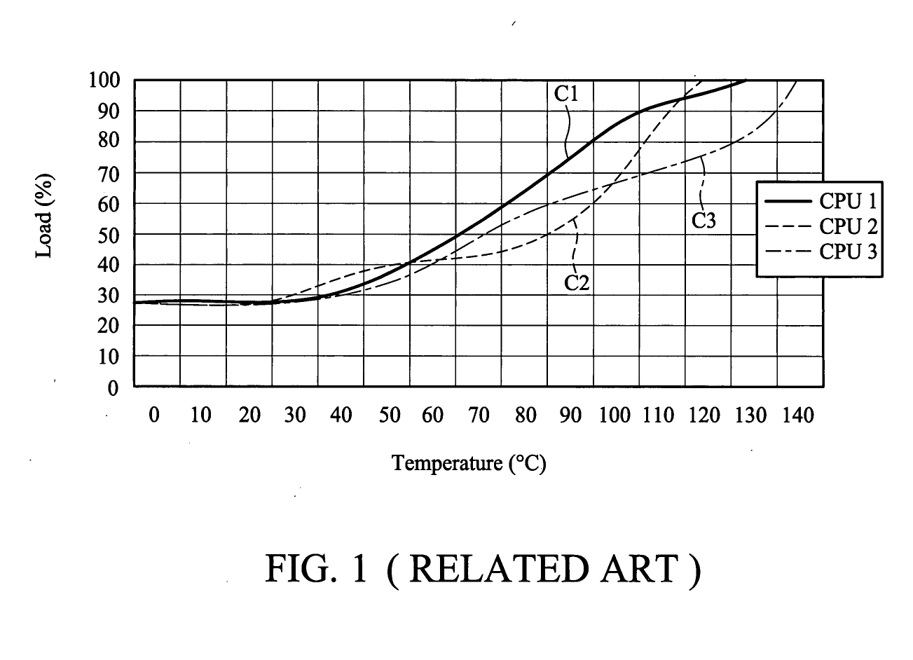

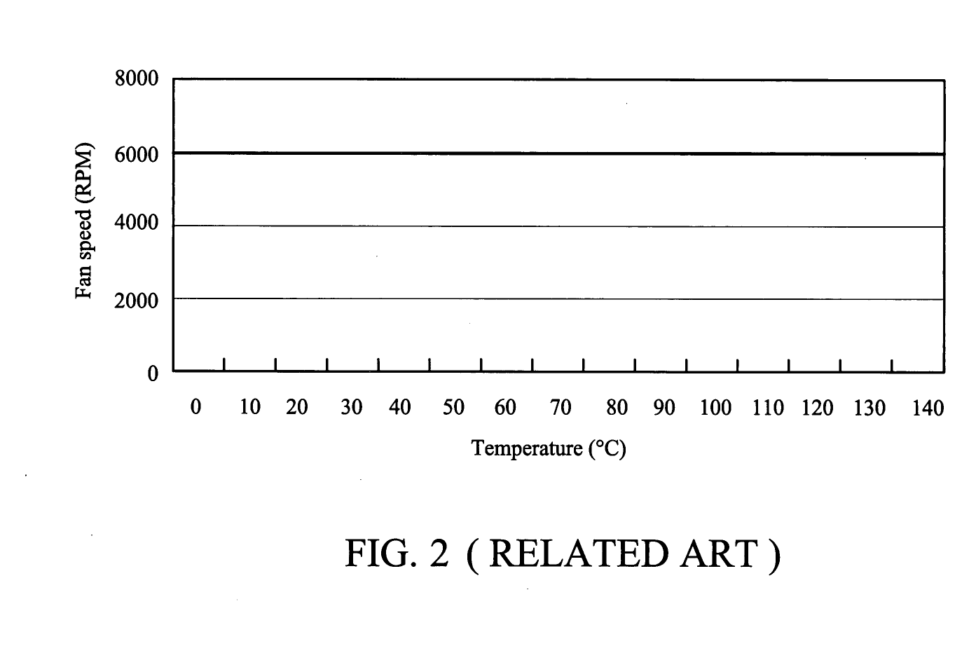

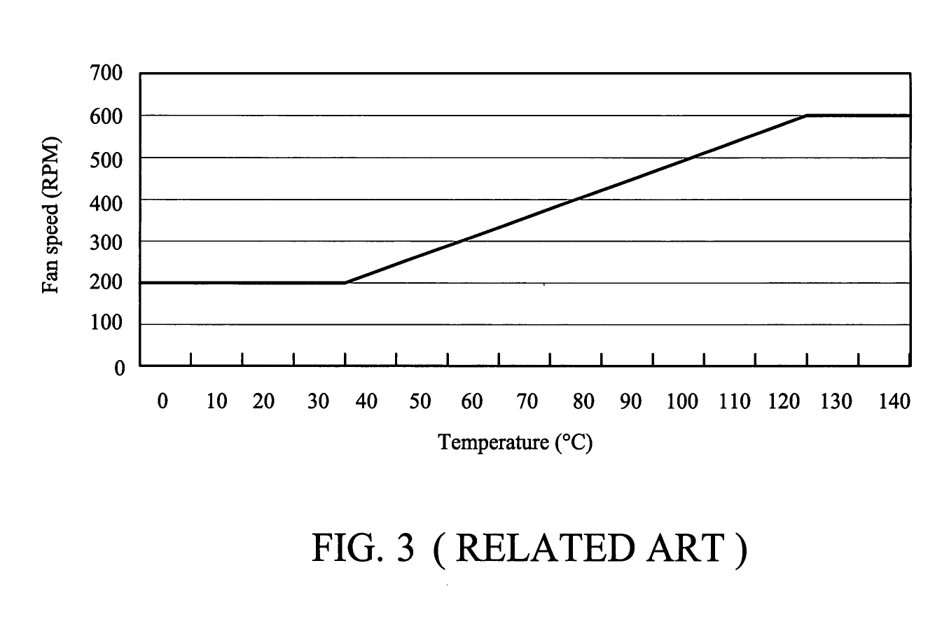

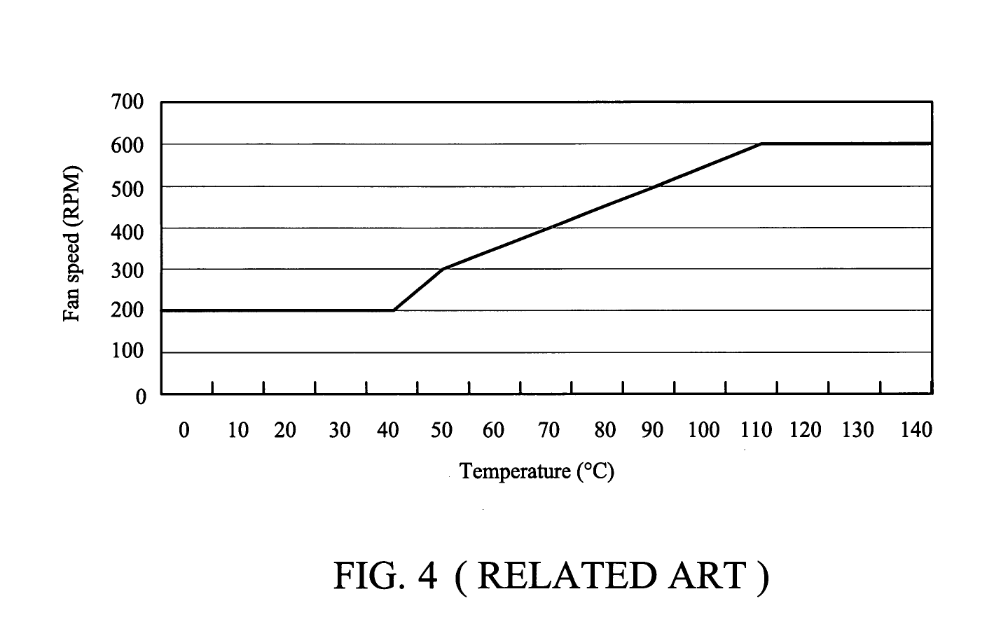

### DETAILED DESCRIPTION OF THE INVENTION

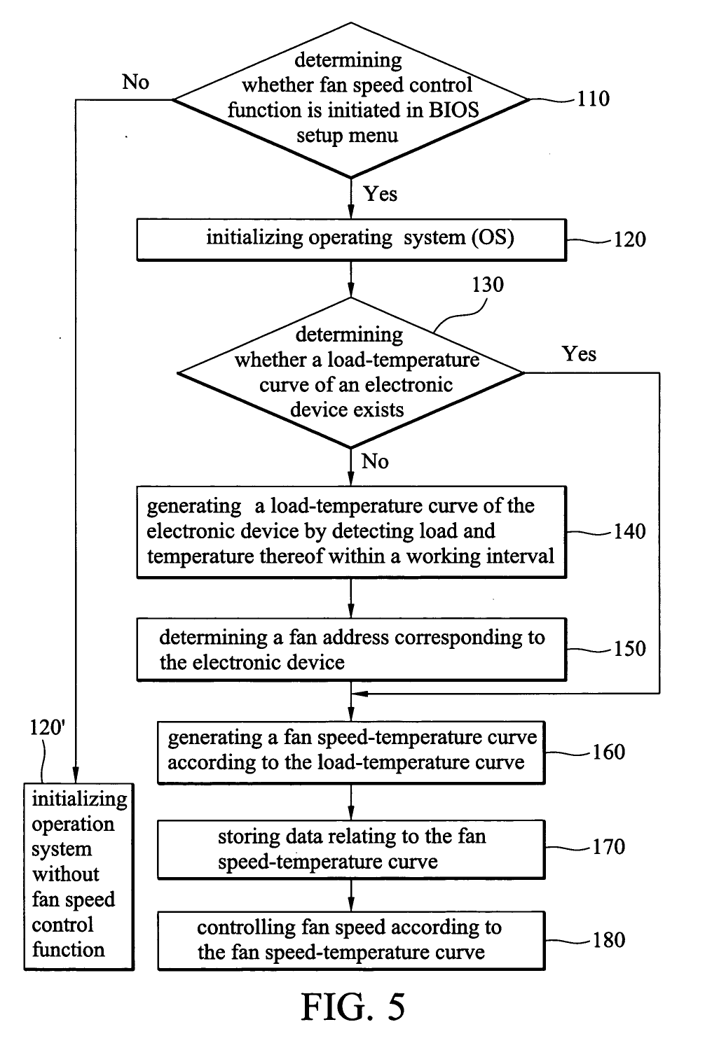

FIG. 5 shows an embodiment of a method of fan speed control, to dissipate heat from an electronic device. The electronic device can be a CPU, IC, motherboard, or power supply of a computer.

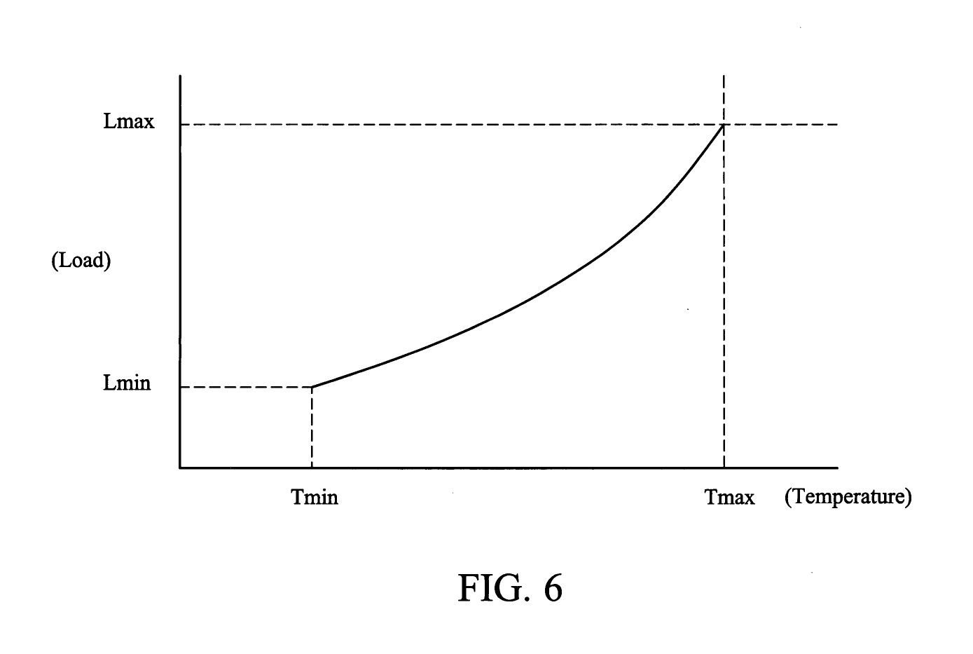

As shown in FIG. 5, from a BIOS (Basic Input Output System) setup menu, a fan speed control mode can be defined to initiate a fan speed control function (step 110) and initialize an operating system (step 120), or directly initialize an operating system without fan speed control (step 120′). Once the fan speed control function is initiated in BIOS setup menu, in step 130, it is determined whether a load-temperature curve corresponding to an electronic device exists in the operating system. An exemplary embodiment of the load-temperature curve is depicted in FIG. 6, wherein Lmax and Lmin represent maximum and minimum loads of the electronic device within a working interval, and Tmax and Tmin represent maximum and minimum temperatures thereof within the working interval.

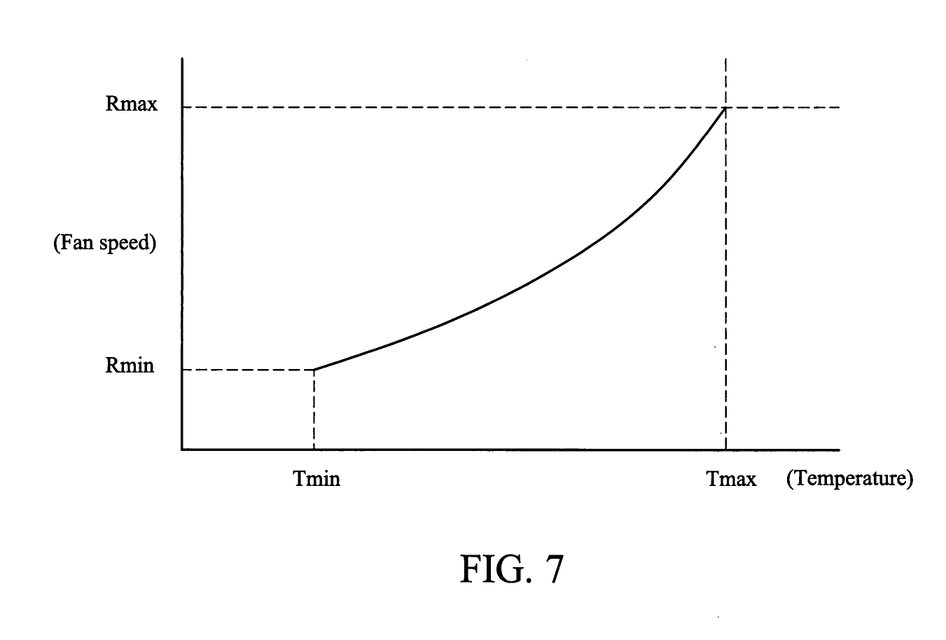

If the load-temperature curve of the electronic device is located in step 130, in subsequent step 160, a fan speed-temperature curve is generated according to the load-temperature curve. An exemplary embodiment of a fan speed-temperature curve is depicted in FIG. 7, wherein Rmax and Rmin represent maximum and minimum fan speeds. In this embodiment, the fan speed-temperature curve of FIG. 7 has a profile similar to that of FIG. 6, adapted to function and electrical properties of the electronic device. After step 160, data relating to the fan speed-temperature curve is stored (step 170), and the fan speed is controlled according to the fan speed-temperature curve (step 180).

Alternatively, if the load-temperature curve of the electronic device is not located in step 130, in subsequent step 140, a load-temperature curve is generated corresponding to the electronic device by detecting load and temperature thereof within a working interval, as shown in FIG. 6. After step 140, a fan address corresponding to the electronic device is determined (step 150), and a fan speed-temperature curve is subsequently generated, corresponding to the load-temperature curve (step 160), as shown in FIG. 7. Here, the fan speed-temperature curve of FIG. 7 has a profile similar to that of FIG. 6, adapted to function and electrical properties of the electronic device. However, the profile of the fan speed-temperature curve can also be appropriately altered by demand, to balance cooling efficiency and electrical power consumption. As the steps 170 and 180 shown in FIG. 5, the data relating to the fan speed-temperature curve is stored in memories, and the fan speed is subsequently controlled according to the fan speed-temperature curve.

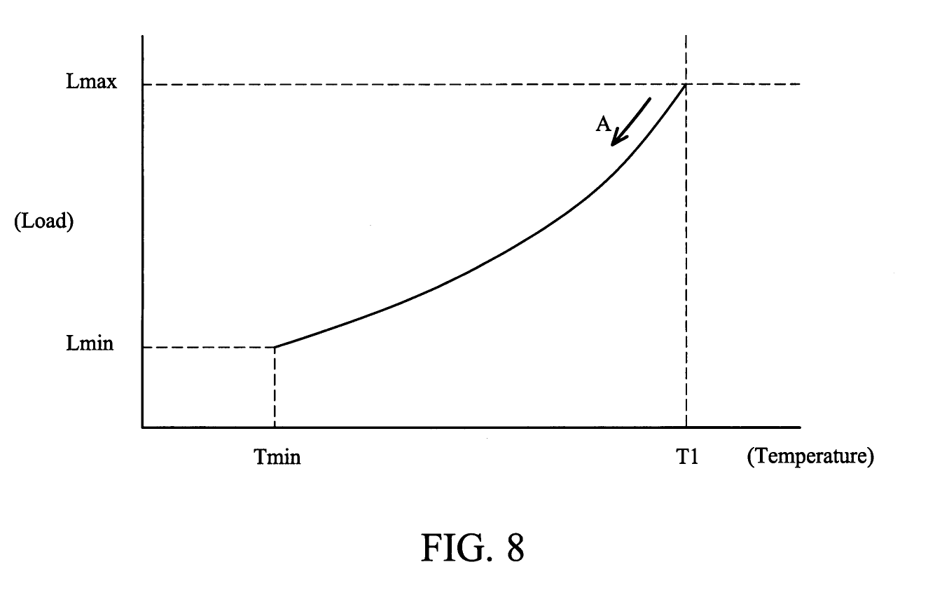

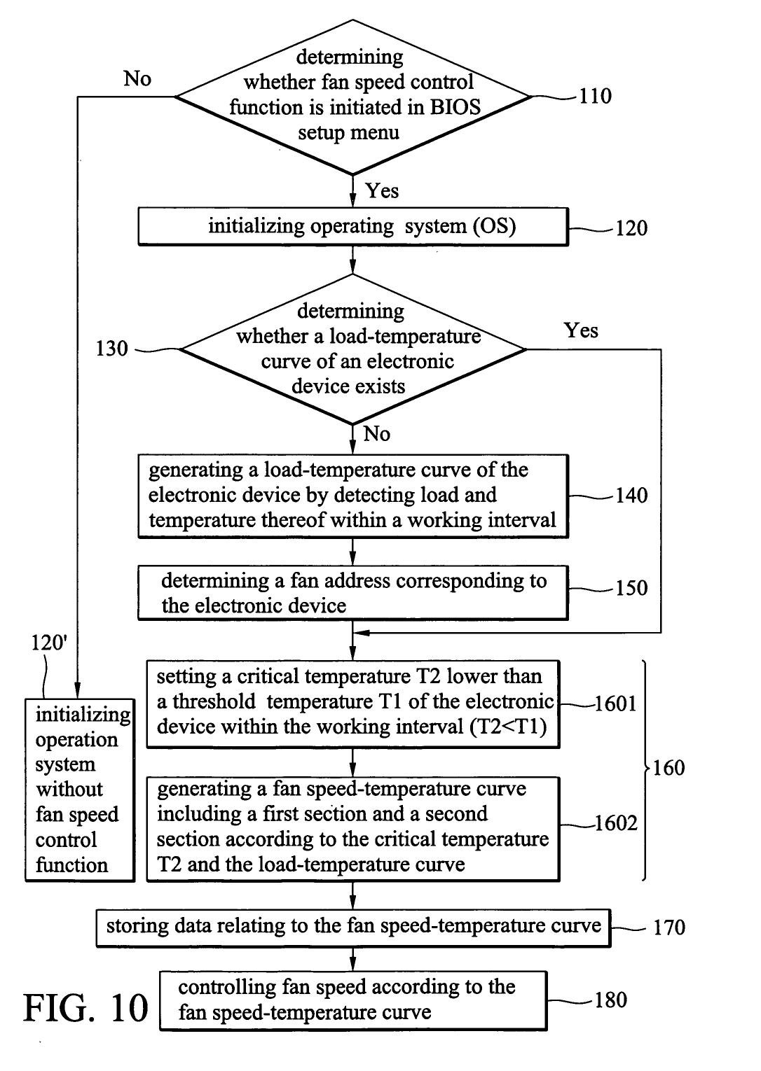

FIG. 8 shows a load-temperature curve of another electronic device, such as a CPU having a temperature control circuit (TCC). The load-temperature curve of FIG. 8 is generated by detecting load and temperature of the electronic device within a working interval, as in step 140 shown in FIG. 10. Specifically, when the electronic device reaches a threshold temperature T1, the temperature control circuit automatically reduces working frequency of the electronic device to lower load and temperature thereof, as the arrow A indicates in FIG. 8. However, working frequency reduction can adversely affect performance of the electronic device.

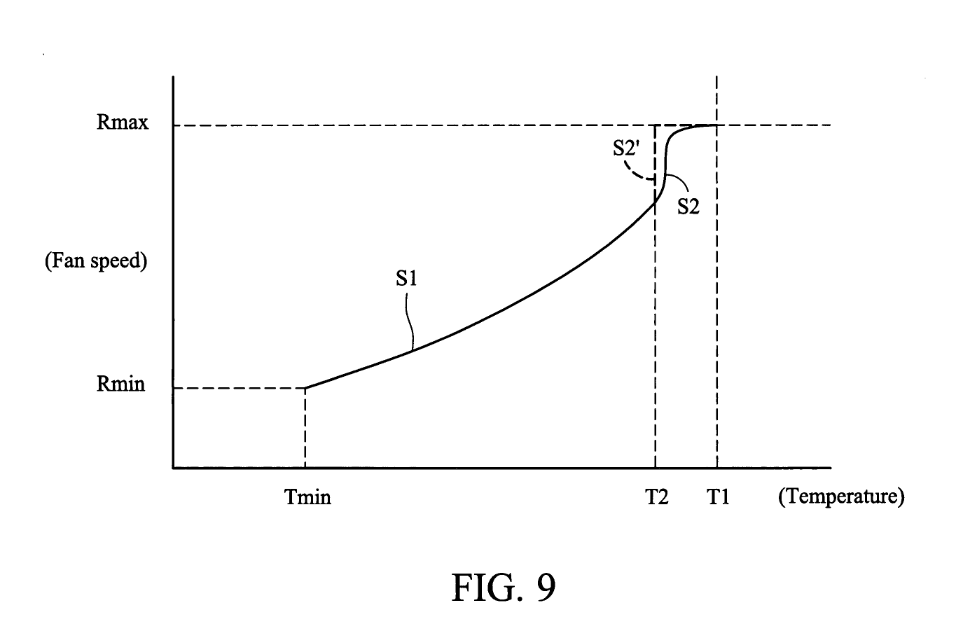

To maintain performance of the electronic device and prevent working frequency reduction thereof, a modified fan speed-temperature curve is provided in FIG. 9, corresponding to the load-temperature curve in FIG. 8. FIG. 10 shows a method of fan speed control, including generating the fan speed-temperature curve of FIG. 9. The difference between FIG. 10 and FIG. 5 is that the step 160 in FIG. 10 comprises steps 1601 and 1602. The steps in FIG. 10 corresponding to those of FIG. 5 share the same reference numerals, and explanation thereof is omitted for simplification of the description.

Referring to FIG. 10, when the load-temperature curve corresponding to the electronic device is determined, in subsequent step 1601, a critical temperature T2 less than the threshold temperature T1 within the working interval is set. In step 1602, the fan speed-temperature curve is generated according to the load-temperature curve including a first section S1 (from the minimum temperature Tmin to the critical temperature T2) and a second section S2 (from the critical temperature T2 to the threshold temperature T1), as shown in FIG. 9. Here, the fan speed-temperature curve is divided into the first and second sections S1 and S2 by the critical temperature T2.

In this embodiment, the first section S1 in FIG. 9 has a profile similar to the load-temperature curve of FIG. 8. Here, however, the second section S2 rapidly rises to a maximum fan speed Rmax to enhance heat dissipation from the electronic device, wherein maximum slope of the second section S2 exceeds that of the first section S1. When fan speed increases to Rmax upon the critical temperature T2 being exceeded, the electronic device is cooled in a timely manner, and working frequency reduction of the electronic device from the temperature control circuit (TCC) is prevented. In some embodiments, the fan speed can also suddenly jump to Rmax to rapidly cool the electronic device at the critical temperature T2, as in second section S2′ shown in FIG. 9. However, the first and second sections S1 and S2 can also be appropriately altered by demand, to balance cooling efficiency and electrical power consumption.

Fan speed control methods are provided according to the embodiments. The fan speed is controlled by a fan speed-temperature curve to improve cooling efficiency and conserve power. Specifically, the fan speed-temperature curve corresponds to a load-temperature curve of the electronic device, adapted to specific function and electrical properties thereof. In some embodiments, a plurality of different load-temperature curves and fan speed-temperature curves are produced to control fan speed of several fans, corresponding to the electronic devices, such as CPU, IC, motherboard and power supply of a computer. The fans are individually controlled by the fan speed-temperature curves to improve cooling efficiency and conserve electrical power.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of fan speed control of a computer, the computer comprising at least an electronic device and a fan to dissipate heat therefrom, the method comprising:
generating a load-temperature curve of the electronic device by detecting load and temperature thereof within a working interval; and
generating a fan speed-temperature curve according to the load-temperature curve; and
controlling the fan speed according to the fan speed-temperature curve.

2. The method as claimed in claim 1, further comprising determining whether the load-temperature curve exists, in an operating system of the computer.

3. The method as claimed in claim 1, further comprising determining a fan address corresponding to the fan and the electronic device.

4. The method as claimed in claim 1, further comprising storing data relating to the fan speed-temperature curve.

5. The method as claimed in claim 1, wherein the method is initiated in a BIOS setup menu of the computer.

6. The method as claimed in claim 1, wherein the computer comprises a plurality of electronic devices and fans corresponding thereto.

7. The method as claimed in claim 1, wherein the electronic device comprises an IC.

8. The method as claimed in claim 1, wherein the electronic device comprises a motherboard.

9. The method as claimed in claim 1, wherein the electronic device comprises a power supply.

10. The method as claimed in claim 1, wherein the electronic device comprises a CPU.

11. The method as claimed in claim 1, wherein generation of the fan speed-temperature curve comprises setting a critical temperature less than a threshold temperature of the electronic device within the working interval.

12. The method as claimed in claim 11, wherein the fan speed-temperature is divided into a first section and a second section by the critical temperature, wherein the profile of the first section substantially corresponds to the load-temperature curve, and maximum slope of the second section exceeds that of the first section.

13. The method as claimed in claim 12, wherein the second section of the fan speed-temperature rises to a maximum fan speed within the working interval.

14. The method as claimed in claim 11, wherein the electronic device comprises a temperature control circuit reducing working frequency of the electronic device when exceeding the threshold temperature.

15. The method as claimed in claim 11, wherein the fan speed-temperature jumps to a maximum fan speed within the working interval when the electronic device reaches the critical temperature.
